(19) United States
(12) Patent Application Publication
(10) Pub. No.: US 2004/0067062 A1
(43) Pub. Date: Apr. 8, 2004

(54) Wavelength dependent polarization modification

(76) Inventor: Thomas Stefany, Altdorf (DE)

Correspondence Address: PERMAN & GREEN, 425 POST ROAD, FAIRFIELD, CT, 06824, US

(21) Appl. No.: 10/264,690

(22) Filed: Oct. 4, 2002

(51) Int. Cl. H04B 10/18

(52) U.S. Cl. 398/147

(57) ABSTRACT

Disclosed is a method for a wavelength dependent polarization modification for a polarization controller using a model for determining the parameter α and β for the setting of at least one wavelength dependent optical component of the polarization controller. The model is provided for compensation of a wavelength dependent polarization of the at least one optical component. The model is further providing the determined setting to the at least one optical component for modifying the input state of polarization of the incident optical beam to the desired output state of polarization. Therefore, the wavelength depending optical components and the input state of polarization of the incident beam will be considered by the modification for the desired output state of polarization.

### BACKGROUND OF THE INVENTION

The invention relates to modifying a state of polarization of an incident optical beam having an input state of polarization to a desired output state of polarization.

From the publication “PDL measurements using the Agilent 8169 A Polarization Controller”, Agilent Technologies, Jan. 9, 2002, http://literature.agilent.com/litweb/pdf/5964-9937E.pdf, it is known to calibrate the orientation for quarter- and half-wave plates for desired output state of polarization by using a concrete design wavelength for an emerging light beam.

### SUMMARY OF THE INVENTION

It is an object of the invention to provide an improved modifying of a state of polarization of an incident optical beam having an input state of polarization to a desired output state of polarization. This object is solved by the independent claims. Preferred embodiments are shown by the dependent claims.

The invention thus allows modifying an input state of polarization on an incident optical beam to a desired output state of polarization by considering the wavelength dependency of the at least one optical component used for modifying the state of polarization. The setting for the at least one component is determined by a model which is provided for the compensation of wavelength dependency. This enables a systematically determination of the setting for the at least one component.

In a preferred embodiment the desired output state of polarization is determined by an iterative process by modifying at least one parameter for the setting of the at least one optical component. For example in a first step the expected output state of polarization will be determined with a first setting value of at least one parameter. In a second step the expected output state of polarization P_{D} is compared with a desired state of polarization P_{D} to determine the deviation. In a next step the at least one parameter for the setting will be modified for a next expected output state of polarization D_{D} until the determined expected and the desired output state of polarization at least substantially matches.

In a preferred embodiment the parameters are determined as a first parameter α for a quarter-wave plate and as a second parameter β for a half-wave plate to modify the position or the orientation at the wave plates representing the optical components.

In a preferred embodiment the parameters α and β are representing a value in degree for positioning the quarter-wave plate and the half-wave plate. Both plates are adapted for modifying the state of polarization. For modifying the input state of polarization of the incident optical beam to the desired output state of polarization at least one parameter α and β will be varied. If the difference between the determined expected output state of polarization and the desired output state of polarization is decreasing the orientation for the parameters α and β will be continued. If the difference increases the orientation for setting the optical components will be changed in opposite direction. This procedure will be repeated until the deviation tends to or is zero. The setting values α and β for the last determined expected output state of polarization will give a value in degree for adjusting the quarter- and half-wave plates of the optical device.

In a further embodiment of the invention the model is starting with an analysis by the Jones calculus. Jₒᵤₜ=J_{Hwp} (λ,β) J_{Qwp} (λ,α)Jᵢₙ wherein Jₒᵤₜ represents the Jones vector for the outcoming light beam with desired output polarization state P_{D}, J_{Hwp} (λ,α) represents the Jones matrix of the quarter-wave plate and J_{Qwp} (λ,α) represents the Jones matrix of the half-wave plate and Jᵢₙ represents the Jones vector of the incident light beam. The output Jones vector will be transformed into a Stokes vector Jₒᵤₜ→Sₒᵤₜ. To optimize the values for the orientation an error function F, for example F=(S_{1,out}-S₁)²+(S_{2,out}-S₂)²+(S_{3,out}-S₃)², will be used wherein S_{i,out} represents the Stokes parameters of the calculated output polarization state and Sᵢ represents the Stokes parameters of the desired output state of polarization P_{D}. The model and the error function can be used in a nonlinear optimization algorithm, for example Levenberg-Marquardt. If the function F tends to zero the optimization will be achieved. The parameters or setting values α and β for the last determined expected output state of polarization will give a value in degree for adjusting the quarter- and half-wave plates of the optical device.

In an alternative embodiment of the invention the mathematical model is comprising only Mueller-matrices and Stokes-vectors for calculating the orientation α and β. A further alternative embodiment of the invention is to only use as mathematical model Jones-matrices and Jones-vectors for the iteration process.

### BRIEF DESCRIPTION OF THE DRAWING

Other objects and many of the attendant advantages of the present invention will be readily appreciated and become better understood reference to the following detailed description when considered in connection with the accompanied drawing. Features that are substantially or functionally equal or similar will be referred to the same reference sign.

FIG. 1 shows a schematic view of a preferred embodiment according to the present invention.

### DETAILED DESCRIPTION OF EMBODIMENTS OF THE INVENTION

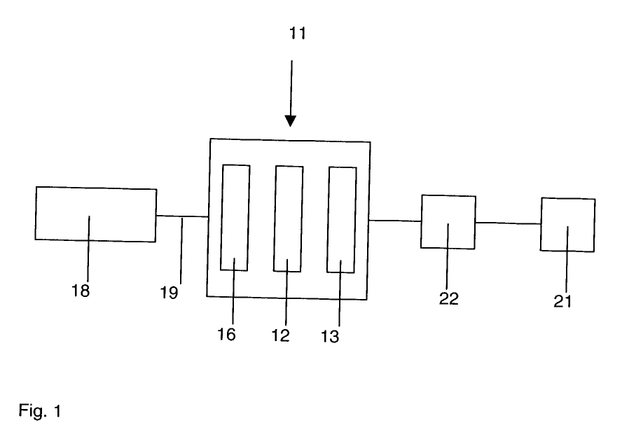

FIG. 1 illustrates a schematic view of an apparatus or an optical device 11 e.g. a polarization controller for modifying a state of polarization of an incident optical beam comprising optical components as for example a quarter-wave plate 12 and a half-wave plate 13. These plates 12, 13 are also known as retarder plates. Those plates 12, 13 are wavelength dependent. The device 11 further comprises an input polarizer 16.

The optical device 11 is used e.g. for polarization dependent loss measurement. To obtain highly accurate polarization dependent loss values it is necessary to define the output state of polarization. For calibrating the optical device 11 an optical source 18, e.g. a laser source, is connected via an optical fiber 19 with the device 11. The output of the device 11 is connected with a detector 21. This setup will be used for the measurement of the polarization dependent loss of optical components 22 whereby such optical devices are positioned between the device 11 and the detector 21.

The quarter-wave plate 12 and the half-wave plate 13 are rotatably positioned in an axis of the incident light beam. The parameters α and β are a value in degree to determine the exact orientation of the plates 12, 13 for adjustment to achieve the desired output state of polarization P_{D}. By using a model the parameters α and β of the quarter- and half-wave plates 12, 13 are calculated by an analysis unit with respect to the desired output state of polarization P_{D}, considering the wavelength and the polarization state of the incident light beam. Further is at least provided a control unit adapted for providing the determined setting to the at least one component 12, 13 for modifying the input state of polarization of the incident optical beam to the desired output state of polarization.

The optical components 12, 13 will be adjusted in an exact manner after the parameters α and β have been determined by modifying the setting values and using the method according to the invention.

What is claimed is:

1. Method for modifying a state of polarization of an optical beam to a desired output state of polarization using at least one optical component adapted for modifying the state of polarization, the method comprising the steps of:
(a) receiving an incident optical beam having an input state of polarization,
(b) using a model for determining a setting of the at least one optical component for deriving the desired output state of polarization, wherein the model is provided for compensating a wavelength dependency of the at least one optical component, and
(c) providing the determined setting to the at least one optical component for modifying the input state of polarization of the incident optical beam to the desired output state of polarization.

2. The method of claim 1, wherein step b comprises the steps of:
(b1) determine an expected output state of polarization for a first setting of the at least one optical component,
(b2) modify at least one parameter of the first setting,
(b3) determine an expected output state of polarization for the modified setting of the at least one optical component, and
(b4) repeat steps b2 and b3 until the determined expected output state of polarization at least substantially matches with the desired output state of polarization.

3. The method of claim 1, wherein the at least one optical component comprises at least one of: a quarter-wave plate adapted for modifying the state of polarization in a first way determined by a first parameter, and a half-wave plate adapted for modifying the state of polarization in a second way determined by a second parameter.

4. The method of claim 3, wherein the first parameter represents an orientation of a quarter-wave plate with a first value in degree and the second parameter represents an orientation of a half-wave plate with a value of degree and at least one of the parameter is determined for the expected output state of polarization.

5. The method of claim 1, wherein the model is based on at least one of a group comprising:
a Mueller/Stokes analysis for determining the setting of the at least one optical component,
a combination of the Jones calculus and the Mueller/Stokes calculus for determining the setting of the at least one optical component,
the Jones calculus for determining the setting of the at least one optical component.

6. The methods of claim 5 further comprising a step of implementing an algorithm for optimization of an error function.

7. Apparatus for modifying a state of polarization of an incident optical beam having an input state of polarization to a desired output state of polarization, comprising:
at least one optical component adapted for modifying the state of polarization,
an analysis unit adapted for using a model for determining a setting of the at least one optical component for deriving the desired output state of polarization, wherein the model is provided for compensating a wavelength dependency of the at least one optical component, and
a control unit adapted for providing the determined setting to the at least one optical component for modifying the input state of polarization of the incident optical beam to the desired output state of polarization.
